(19) United States
(12) Patent Application Publication
(10) Pub. No.: US 2012/0029729 A1
(43) Pub. Date: Feb. 2, 2012

(54) REMOTE CONTROL SYSTEM FOR A HYBRID VEHICLE

(76) Inventors: Feisel Weslati, Troy, MI (US); Karthik Ramalingam, Commerce, MI (US)

(21) Appl. No.: 12/844,872

(22) Filed: Jul. 28, 2010

(51) Int. Cl. B60W 20/00

(52) U.S. Cl. 701/2; 903/903

(57) ABSTRACT

A remote control system for a hybrid vehicle includes an input device for selection of one or more features of the hybrid vehicle. The one or more features include control of an electric motor within the vehicle. The system also includes a remote device. The system also includes a configurable remote control module for control of the one or more features based on the selection. The remote control module promotes control of the one or more features in response to a signal from the remote device.

### FIELD

The present invention relates to remote activation devices for vehicles, and more particularly, to remote activation devices for hybrid vehicles.

### BACKGROUND

A remote starter is typically used so that an operator can start a vehicle by a transmitter, such as a key fob, without actually being inside the vehicle. For a typical remote starter, an operator can simply push a button on the transmitter to start the vehicle.

Current remote starters for vehicles are configured to remotely start an internal combustion engine.

### SUMMARY

A remote control system for a hybrid vehicle includes an input device for selection of one or more features of the hybrid vehicle. The one or more features include control of an electric motor within the vehicle. The system also includes a remote device. The system also includes a configurable remote control module for control of the one or more features based on the selection. The remote control module promotes control of the one or more features in response to a signal from the remote device.

In other features, the remote device includes a selection area for actuating a remote start of the electric motor. The one or more features include climate control features. The one or more features include air conditioning control, window control and seat control. The one or more features include controlling a vehicle battery condition. The one or more features include at least one of opening and closing windows based on a preselected temperature. The one or more features include at least one of activating the control of heating and cooling functions for vehicle seats based on a preselected temperature.

In other features, the system includes a feature selection module that selects a plurality of features based on the one or more features that were selected using the input device. The system also includes a feature activation module that activates control of the plurality of features. The system also includes an engine control module that promotes control of the electric motor. The input device is positioned at a dashboard of the vehicle.

In other features, the one or more features include promoting control of an internal combustion engine. The remote control module promotes control of an internal combustion engine. The system also includes promoting control of A/C, seats, mirrors, audio presets, battery condition, electric motor condition engine/transmission condition, and combinations thereof. The remote control module activates the control of the one or more features including actuating a stop or a start condition of the feature.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a remote control system according to the present disclosure;

FIG. 2 is a block diagram illustrating the remote control system according to the present disclosure;

FIG. 3 is a block diagram of a configurable remote control module according to the present disclosure; and

FIG. 4 is a block diagram illustrating a method for operating a remote control system according to the present disclosure.

### DETAILED DESCRIPTION

As used herein, the term module refers to components, devices and systems that are electric and/or mechanical that provides signals, instructions, and/or activates other vehicle components and systems. Modules can include all those functions listed above. Further, a module may be an Application Specific Integrated Circuit (ASIC), an electronic circuit, a processor (shared, dedicated, or group) and memory that execute one or more software or firmware programs, a combinational logic circuit, and/or other suitable components that provide the described functionality.

The present disclosure is directed to embodiments of a configurable remote control system for a hybrid vehicle. The remote control system includes a remote device, such as a key fob, that sends a remote signal to a configurable remote control module of a hybrid vehicle. The remote control module is configured based on user inputs to activate various vehicle functions in response to signals from the remote device. The remote control system may include memory to store selections that are specific to different users. Examples of vehicle functions include but are not limited to starting an electric motor, an internal combustion engine, activating air conditioning (AC), activating heated or cooled seats, adjusting seat position, turning on a radio, pre-conditioning a battery, pre-conditioning a transmission for optimal driving performance, and activating various other vehicle functions for occupant comfort or enhanced drivability.

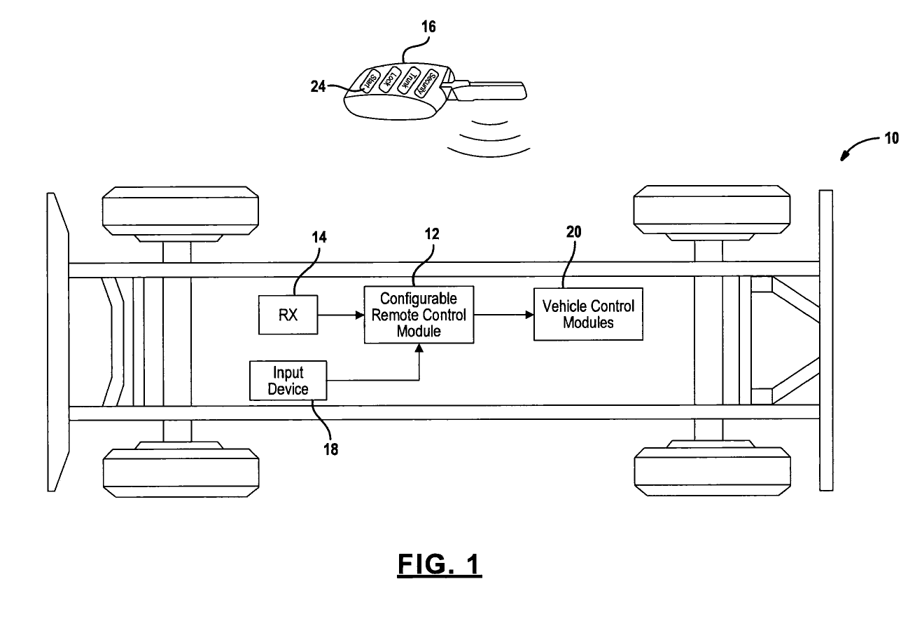

Referring now to FIG. 1, a remote control system 10 includes a configurable remote control module 12. The configurable remote control module 12 receives signals from a remote device 16 via a receiver 14 to activate a vehicle function. One or more vehicle components/subsystems and/or modifications thereof are preselected by a vehicle operator utilizing the remote control module. The configurable remote control module 12 is configured so that the one or more vehicle components/subsystems are controlled when a remote function is activated. Therefore, a remote activation can include control of vehicle ignition and various other vehicle subsystems, which will be discussed herein, depending on the configuration of the remote control module 12.

The configurable remote control module 12 is configurable based on user inputs to an input device 18. A vehicle operator selects using input device 18 one or more selection options to configure the configurable remote control module 12. In one embodiment, the input device 18 is positioned at a dashboard (not shown) of the vehicle. In one embodiment, the input device 18 includes touch-screen menu options, a plurality of buttons, and/or other selection devices. In an exemplary embodiment, selection options include internal combustion engine, electric motor, air conditioning, window control, and seat control. In alternative embodiments, various other vehicle systems and devices may also be selected via the input device 18.

The configurable remote control module 12 sends signals to various vehicle control modules 20 based on the user input and signals from the remote device 16. In one embodiment, the remote device 16 includes various selection areas (e.g., buttons 24) that indicate different functions, for example, remote start, vehicle locks, trunk operation, seat position, windows, a security feature such as a panic alarm, etc. Various other functions may also be represented by the areas. In one embodiment, the start button is depressed to send a signal to the receiver 14 to initiate a remote start of the vehicle engine or electric motor.

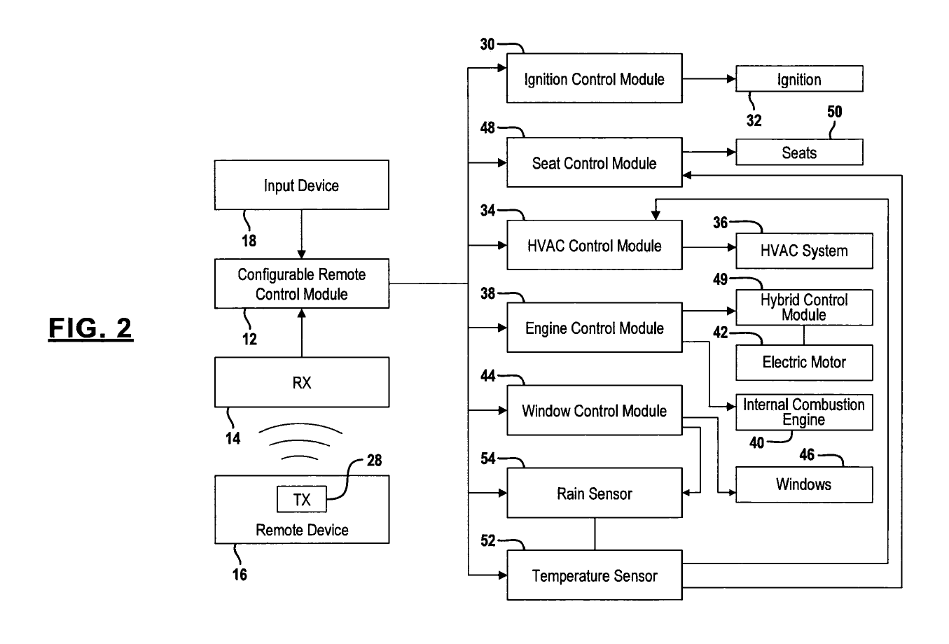

Referring now to FIG. 2, the remote control system 10 is illustrated in more detail in accordance with an exemplary embodiment. The remote device 16 includes a transmitter (TX) 28 that transmits signals from the remote device 16 to the receiver (RX) 14. When the configurable remote control module 12 receives signals from the receiver 14, the configurable remote control module 12 promotes the control of one or more of vehicle components and subsystems that were selected via the input device 18. Promoting control can include activating, deactivating or otherwise modifying or adjusting the selected vehicle components and subsystems.

Examples of vehicle subsystems include control modules and control devices, such as an ignition control module 30 that controls a vehicle ignition 32, a HVAC control module 34 that controls HVAC system 36, and an engine control module 38 that controls an internal combustion engine 40. In an exemplary embodiment, the configurable remote control module 12 also can activate the engine control module 38 to send a signal to a hybrid control module 49 to control an electric motor 42. Other control modules that can be activated by the configurable remote control module 12 include a window control module 44 that controls windows 46 on the vehicle, a seat control module 48 that controls heating, cooling and positioning of seats, a battery control module (not shown), a transmission control module (not shown), etc.

Further, the input device 18 may be used to select various features that configure the configurable remote control module 12 to send signals to the remote device 16. For example, the configurable remote control module 12 can be configured to send information (e.g., during a test operation initiated by the remote device 16) to the remote device 16 that indicates conditions of vehicle components/subsystems. Examples of the information that indicates conditions of vehicle subsystems can include cabin temperature, seat temperature, engine on/off modes, battery conditions (state of charge (SOC), temperature, etc.), an overall drivability indication based on transmission temperature, engine temperature, SOC, battery temperature, etc., battery charge status, and vehicle warnings or notifications, such as plug-in status of the vehicle, etc.

In one embodiment, the configurable remote control module 12 instructs the engine control module 38 to activate the internal combustion engine 40 and/or the electric motor 42 via the hybrid control module 49. A vehicle operator may choose to select activation of only the electric motor 42 via the input device 18 and not the internal combustion engine 40. The vehicle operator may also choose to select activation of only the internal combustion engine 40 via the input device 18 and not the electric motor 42. The vehicle operator may also select various other functions, such as heated and/or cooled seats 50, seat position, automatic opening windows 46, radio presets, and automatic A/C temperature control via the HVAC system 36. Selecting the functions may include starting, stopping, adjusting and/or modifying the selected functions corresponding to vehicle components and vehicle systems.

In an exemplary embodiment, the HVAC control module 34, the seat control module 48 and/or the window control module 44 receive signals from a temperature sensor 52, and the window control module 44 also receives signals from a rain sensor 54. In the embodiment, the window control module 44 does not open the windows 46 even when the window function is selected via the input device 18 if the rain sensor 54 indicates that it is raining.

Further, the HVAC control module 34 and the seat control module 48 may activate heating or cooling functions based on signals from the temperature sensor 52. For example, if the temperature sensor 52 indicates that the temperature inside the vehicle is above a preselected threshold, the HVAC system 36 may be controlled to cool the vehicle, and the seats 50 may also be cooled. Further, if the temperature sensor 52 indicates that the vehicle temperature is below a preselected threshold, the HVAC system 36 may be controlled to heat the vehicle; and the seats 50 may also be heated. The preselected thresholds may be set via HVAC controls within the vehicle. For example, air conditioning controls of the HVAC system 36 may be set to a desired temperature by a vehicle operator.

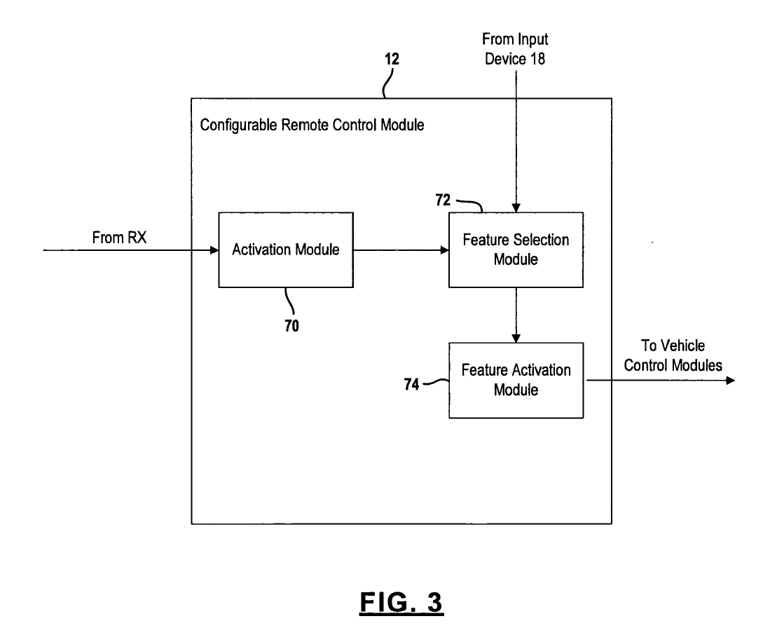

Referring now to FIG. 3, the configurable remote control module 12 is illustrated in more detail in accordance with another exemplary embodiment. The configurable remote control module 12 includes an activation module 70, a feature selection module 72, and a feature activation module 74. The feature selection module 72 receives configuration inputs from the input device 18 indicating which features are to be controlled by the configurable remote control module 12. Features correspond to vehicle sub-modules or other vehicle systems and components. The features indicate which type of engine control is going to be used. For example, the features indicate whether the internal combustion engine 40 or the electric motor 42 will be activated. Other features may include control of windows 46, seats 50 and the HVAC system 36.

The feature selection module 72 selects the features after receiving signals from the activation module 70 indicating that preselected features are to be controlled, such as activated, deactivated or otherwise modified. The preselected features are to be controlled when a signal from the remote device 16 is received by the receiver 14. The feature activation module 74 sends signals to various vehicle control modules to activate the features that were selected by the feature selection module 72. The various control modules then control respective components or devices of the vehicle.

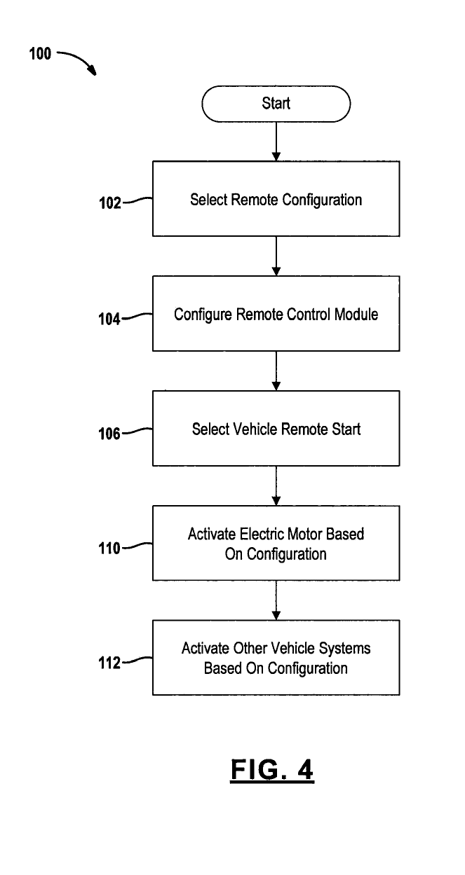

Referring now to FIG. 4, a block diagram 100 illustrates a method for operating the remote control system 10 in accordance with an exemplary embodiment. Control starts in block 102 when a vehicle operator selects a remote configuration via the input device 18. This selection includes selecting from, for example, menu options, a plurality of buttons, and/or other selection devices. Selection options include but are not limited to starting either an electric motor or an internal combustion engine, activating heating/air conditioning (AC), activating heated or cooled seats, adjusting seat position, turning on a radio, pre-conditioning a battery, pre-conditioning a transmission for optimal driving performance, and activating various other vehicle functions for occupant comfort or enhanced drivability. In one embodiment, the engine control module 38 is configured to activate the electric motor 42 without activation of the internal combustion engine 40, thus potentially saving fuel. For example, the engine control module 38 communicates with the hybrid control module 49 to activate the electric motor 42, without activation of the internal combustion engine. Further, the remote control system may be configured to activate the internal combustion engine 40 without activation of the electric motor 42. Still further in another embodiment, a vehicle operator may select both the electric motor feature and the internal combustion engine feature to have both engines start in response to a remote control operation.

In block 104, signals from the input device 18 are received in the vehicle selection module 72 in order to configure the configurable remote control module 12. In block 106, a vehicle operator selects remote start on the remote device 16. In block 110, the particular type of engine activation that was configured via the input device 18 is selected. For example, the vehicle operator may have only selected activation of the electric motor 42, and therefore only the electric motor 42 will activate. Alternatively, the vehicle operator may have only selected activation of the internal combustion engine 40, and therefore only the internal combustion engine 40 will activate.

In block 112, various other vehicle components/systems are controlled based on the configuration that was selected via the input device 18. For example, activating air conditioning (AC), activating heated or cooled seats, adjusting seat position, turning on a radio, pre-conditioning a battery, pre-conditioning a transmission for optimal driving performance, and activating various other vehicle functions for occupant comfort or enhanced drivability may be selected as various configuration options.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A remote control system for a hybrid vehicle comprising:
an input device for selection of one or more features for the hybrid vehicle, wherein the one or more features include control of an electric motor within the vehicle;
a remote device; and
a configurable remote control module for control of the one or more features based on the selection, wherein the remote control module promotes control of the one or more features in response to a signal from the remote device.

2. The remote control system of claim 1, further comprising:
the remote device including a selection area for actuating a remote start of the electric motor.

3. The remote control system of claim 1, wherein the input device includes selection of climate control features.

4. The remote control system of claim 3, wherein the one or more features include air conditioning control, window control and seat control.

5. The remote control system of claim 4, wherein the one or more features include controlling a vehicle battery condition.

6. The remote control system of claim 5, wherein the one or more features include at least one of opening and closing windows based on a preselected temperature.

7. The remote control system of claim 3, wherein the one or more features include at least one of activating the control of heating and cooling functions for vehicle seats based on a preselected temperature.

8. The remote control system of claim 1, wherein the remote control module includes:
a feature selection module that selects a plurality of features based on the one or more features that were selected using the input device; and
a feature activation module that activates control of the plurality of features.

9. The remote control system of claim 1, further comprising an engine control module that promotes control of the electric motor.

10. The remote control system of claim 1, wherein the input device is positioned at a dashboard of the vehicle.

11. The remote control system of claim 1, wherein the one or more features includes promoting control of an internal combustion engine.

12. The remote control system of claim 1, wherein the remote control module is configured to send a signal to the remote device, the signal indicative of a condition of a vehicle component or system.

13. The remote control system of claim 1, including promoting control of HVAC, seats, mirrors, audio presets, battery condition, electric motor condition engine/transmission condition, and combinations thereof.

14. The remote control system of claim 1, wherein the control of the one or more features includes actuating a stop or a start condition of the feature.

15. The remote control system of claim 11, wherein the one or more features include sending data to the remote device that indicates a condition of one or more vehicle components/subsystems.

16. A method for operating a remote control system for a hybrid vehicle comprising:
selecting one or more features of the hybrid vehicle, wherein the one or more features include control of an electric motor within the vehicle;
controlling the one or more features based on the selection; and
promoting control of the one or more features in response to a signal from a remote device.

17. The method of claim 16, further comprising:
actuating a remote start of the electric motor.

18. The method of claim 16, wherein selecting one or more features includes selection of climate control features.

19. The method of claim 18, wherein selecting one or more features includes selection of air conditioning control, window control, and seat control.

20. The method of claim 19, wherein selecting one or more features includes controlling a vehicle battery condition, opening and closing windows based on a preselected temperature, and activating the control of heating and cooling functions for vehicle seats based on a preselected temperature.
